(19) United States
(12) Patent Application Publication
(10) Pub. No.: US 2026/0309603 A1
(43) Pub. Date: Oct. 8, 2026

(54) VIBRONIC MEASURING DEVICE

(71) Applicant: Endress+Hauser SE+Co. KG, Maulburg (DE)

(72) Inventors: Sascha D'Angelico, Rheinfelden (DE); Ulrich Preusch, Weil am Rhein (DE)

(21) Appl. No.: 19/477,956

(22) PCT Filed: Mar. 1, 2024
(86) PCT No.: PCT/EP2024/055356

§ 371 Date: Oct. 23, 2025

(30) Foreign Application Priority Data
Apr. 25, 2023 (DE) 10 2023 110 587.6

(51) Int. Cl. G01N 9/00

(52) U.S. Cl. CPC G01N 9/002; G01N 2009/006

(57) ABSTRACT

The invention relates to checking the functional capability of vibronic measuring devices (1). In such case, the amplitude of the excitation signals (ES1, ES2), with which a mechanically oscillatable unit (111) is excited, is changed. The checking occurs based on the received signals (RS1, RS2) received from the mechanically oscillatable unit (111).

The invention relates to functionality testing of vibronic measuring devices.

In automation technology, field devices are often applied, which serve for registering and/or influencing process variables. Applied for registering process variables are sensors, which serve, for example, for measuring fill level, limit level, flow, pressure, temperature, pH value, conductivity or dielectric constant. If of concern is the measuring of a medium in a container, then “container” within the scope of the invention refers also to non-closed containments, such as, for example, vats, lakes or oceans or flowing bodies of water.

Applied for limit level measurement are, for example, measuring devices, which operate based on the vibronic measuring principle. Such a measuring device type is shown, for example, in the publication DE 10 2012 101 667 A1: Fundamentally, such measuring devices use vibronic sensors having a mechanically oscillatable element, such as an oscillatory fork, and an amplifier unit back-coupled thereto (see e.g. also DE 100 50 299 A1). For determining viscosity of a medium, for example, the frequency-phase curve is used in WO 02/31471 A2. It is also known to measure process variables based on the decay behavior (see DE 102 03 461 A1).

For converting between mechanical oscillations and electrical signals, a piezoelement or comparable component is mechanically coupled to the oscillatory fork, such that it can be caused to perform mechanical oscillations by an electrical excitation signal. From the mechanical oscillations, an electrical, received signal is produced, whose frequency corresponds to that of the oscillations.

The received signal is either tapped at that piezoelement, by means of which the mechanical oscillation is in excited. In such case, the received signal must according to the state of the art be appropriately separated from the excitation signal. Alternatively, also a separate, second piezoelement, which is likewise mechanically correspondingly coupled with the mechanically oscillatable element, e.g. the oscillatory fork, can function as output for the received signal.

The signal output of the mechanically oscillatable unit for the received signal is led to the amplifier unit, while the output of the amplifier unit is connected to the input for the electrical excitation signal at the oscillatory fork. If the amplifier unit provides a constant phase shift between the entering received signal and the emanating excitation signal and has sufficient signal amplification, then an oscillatory circuit forms, in the case of which the frequency of the excitation signal agrees with that of the received signal. In such case, this frequency depends, on the one hand, on the phase shift predetermined by the amplifier unit (see e.g. WO 2017/215875 A1). On the other hand, the frequency is influenced by the resonance of the oscillatory fork and therewith by a possible covering of the oscillatory fork with the medium, whose density, or limit level, is to be determined. Accordingly, by measuring the current frequency of the excitation signal, or of the received signal, a possibly reached limit level and/or density of the medium can, in principle, be determined.

The vibronic measuring principle functions faultlessly when the oscillatory circuit is not superimposed by external disturbing influences, such as vibrations or electromagnetic disturbance fields. Vibrations can arise, for example, from operation of the process plant, such as the operation of conveyor belts and pumps. In such case, there is the danger that the corresponding disturbance signals superimpose on the exciter-, or received signal, whereby the limit level-, or density measurement can be corrupted. Problematic is especially when, within the process plant, in which the measuring device is applied, it is not detected that the measuring device no longer functions reliably in this regard. Depending on country and process plant, there govern in this regard special specifications, or permitting steps, for field devices, which define the ability to check the correct functioning of field devices, an example being the standards IEC 61508/IEC61511 known under the label “Safety Integrity Level (SIL)”.

Different testing possibilities for measuring devices are known in the state of the art.

Described in DE 20 2005 008 627 U1 is a measuring device with an oscillatable unit and a function test unit. The function test unit acts on the signal received from the oscillatable unit and produces therefrom a test signal, which is processed by a downstream evaluation unit. The test signal corresponds, in such case, to a defined measured value. Thus, the electronics arranged after the oscillatable unit is checked. In another electronics check, EP 1 091 199 B1 provides that a signal generator produces a test signal.

DE 10 2019 131 485 A1 describes the monitoring of a coil as part of the sensor. The coil is supplied with an excitation signal and the received signal is evaluated. Thus checked is a component as part of the transducer unit between electrical signals and mechanical oscillations.

In WO 2017/097528 A1, the mechanically oscillatable unit is excited to perform oscillations in a test mode with different frequencies, in order to detect failure states from the received signals. The processing of such spectra, which result from a frequency sweep, can, according to DE 10 2021 129 416 A1, occur using a neural network.

In WO 2016/128217 A1, the exciting of the mechanically oscillatable unit occurs with a signal resulting from a carrier signal having a carrier frequency and a modulation signal having a modulation frequency. The received signal is composed of a carrier signal and a modulation signal, each of which permits ascertaining a process variable. From a phase shift between the modulation signals, an attenuation is ascertained, which can display, whether e.g. accretion, corrosion or aging effects are occurring.

In DE 10 2016 120 326 A1, the state of the oscillatory circuit is deduced from the time development of the quality of the oscillatory circuit, which includes the oscillatable unit and a piezoelement.

In WO 95/20749 A1, during a test phase, the oscillatory circuit composed of an amplifier circuit and the transducer unit, which excites the oscillatable unit to perform oscillations and receives its oscillations and converts them into electrical signals, is opened. From the decay behavior and, especially, the phase difference between the output signal of the amplifier circuit and the signal taken from the transducer unit, failures are detected.

WO 2020/165560 A1 provides that in a test mode the mechanically oscillatable unit is excited with an excitation signal in order that it perform oscillations, whose frequency has been measured in the preceding measurement operation. This is done in the case of opened oscillatory circuit. From the time development of the amplitudes of the received signals, in comparison with associated threshold values, the function state of the measuring device is deduced.

DE 10 2004 050 494 A1 provides that an oscillatable unit is excited in two different oscillation modes. One of the two modes is not influenced by the medium and, consequently, enables monitoring of the sensor.

In order to detect the presence of failures according to DE 10 2005 009 580 B4, the amplitudes and frequencies of the oscillations are evaluated and the results won in such case are compared with one another.

For checking an oscillatable unit, DE 103 18 445 A1 provides that a component of the oscillatable unit can be manually damped. Thus, a targeted failure state of the mechanics is produced.

In DE 10 2012 102 589 A1, by moving through a frequency range, which lies higher than the frequency range occurring in normal operation, it is detected, whether a lack of oscillations is the result of a covering or corrosion of the oscillatable unit.

For the monitoring of polarization of a piezoelectric element used for driving the oscillatable unit, its capacitance is ascertained and evaluated in DE 10 2017 130 530 A1.

If material clings to the oscillatable unit, then such can likewise lead to a failure state, since then free oscillations are not possible in the actually uncovered state.

In order to detect the aforementioned accretion, DE 103 28 296 A1 defines a limit value for the oscillation frequency, whose subceeding triggers an alarm. DE 10 2009 045 204 A1 provides detecting presence of accretion based on the amplitude curve of the received oscillations versus frequency sweep.

DE 10 2012 101 667 A1 is concerned with foreign vibrations. Such are detected, in that the mechanically oscillatable unit without excitation serves only for detecting oscillations. These ideas are also expressed in DE 10 2016 124 740 A1.

An object of the invention is to provide a measuring device, which is especially checkable regarding its correct functioning with reference to possible disturbances.

The object is achieved by measuring device for determining and/or monitoring a measured variable of a medium, comprising a vibronic sensor and a control unit, wherein the vibronic sensor includes a mechanically oscillatable unit and an amplifier unit, wherein the mechanically oscillatable unit is excitable by an electrical excitation signal having an excitation oscillation frequency and produces a received signal having a resonance oscillation frequency, wherein the amplifier unit is designed to produce the electrical excitation signal with a defined phase shift relative to the received signal and to excite the mechanically oscillatable unit therewith, wherein the control unit is designed to ascertain the resonance oscillation frequency and/or an amplitude of the received signal and based on the ascertained resonance oscillation frequency and/or the ascertained amplitude of the received signal to determine the measured variable of the medium, wherein the control unit is designed to control the amplifier unit for a checking of the measuring device in such a manner that the amplifier unit produces at least two excitation signals with equal excitation oscillation frequency and different predeterminable signal strengths, wherein the control unit is designed to judge the sensor relative to its ability to function depending on how the amplitudes of the received signals behave as a result of the different excitation signals, and wherein the amplifier unit and the mechanically oscillatable unit form a closed oscillatory circuit.

According to the invention, the control unit is distinguished in that it can control the amplifier unit for a checking of the measuring device in such a manner such that the signal strength of the excitation signal is modulated, or changed. If then the received signal changes such as one would expect it to change based on the targeted change of the excitation signal, then this means that the sensor is functioning reliably. If the received signal changes not as expected, then this means, for example, that the mechanically oscillatable element is receiving signals, which are not related to the actual resonance oscillations. Thus, for example, dominant foreign oscillations can be present. It can, however, also be that there is a disturbance in the oscillatory circuit formed by the mechanically oscillatable unit and the amplifier unit, that thus, for example, a cable break, depolarization of a piezoelectric element as part of the transducer unit, detachment of such a piezoelectric element or other damage in the measuring device is present. This would be the case, in which the vibronic sensor cannot oscillate. Thus, if the received signal does not follow the modulation of the excitation signal, then a failure is present.

For the checking, the mechanically oscillatable unit is supplied, especially at different times and, preferably, alternately or interchangeably, with at least two excitation signals, which differ from one another relative to their signal strengths. The signal strength of one excitation signal is, thus, greater than that of the other excitation signal. Correspondingly, it is expected for the defect free case that the received signals, which are received, in each case, for the supplying of the different excitation signals, will differ from one another relative to their amplitudes. The two excitation signals have, in such case, the same frequency and the same phase shift. The frequency is especially that frequency, which establishes during the measuring in the oscillatory circuit of amplifier unit and mechanically oscillatable unit, thus, especially the resonant frequency of the mechanically oscillatable unit (in the undisturbed state essentially only dependent on the medium and its measured variable).

This type of checking enables, above all, continued determining and/or monitoring of the measured variable of the medium interruption free. If no disturbance is present, then the measured variable can be derived and/or monitored from each of the different received signals. This concerns especially the case, in which the frequency of the received signals is evaluated, and, thus, e.g. a change of the covering of the oscillatable unit by the medium would show itself in terms of a measurable frequency change. The checking of the measuring device can, thus, occur without penalties for the measurability and can therewith be referred to as a kind of live-test run in parallel with the measuring.

In the exciting of the mechanically oscillatable unit with the excitation signals, the oscillatory circuit of mechanically oscillatable unit and amplifier unit is, in each case, closed, in order to implement a feedback loop.

For the checking of the sensor, an option is to evaluate the received signals relative to one another. Plus, the received signals can be evaluated singly with reference to the measured variable. The received signals fulfill therewith a double function.

In the context of the invention, there are a number of options for how the excitation signal can be changed, thus, either with jump shaped or continuous (such as, for example, linear or sinusoidal) changes. The control unit is to be designed correspondingly, in order to control the amplifier unit correctly depending on implemention. In an embodiment, two different values are provided for the signal strengths.

In an embodiment, the switching between a first excitation signal with a first signal strength and a second excitation signal with a second signal strength is performed multiple times. Each alternation enables checking the ability of the measuring device to function. Preferably, the alternating between the two excitation signals with the different signal strengths takes place continually during using the measuring device. In an embodiment, it is provided that e.g. in the case of special application conditions the switching of the signal strengths can be turned off and, consequently, does not take place continually.

The exciting with a signal strength is preferably performed, in each case, over a certain time period, which is preferably so selected that a transient behavior is essentially no longer present. The exciting occurs, thus, for example, with the first excitation signal with the first signal strength over an initial period and then with the second excitation signal with the second signal strength over a second time period. Then, the exciting with the first excitation signal occurs again, etc. In an embodiment, the time periods, over which the first, or second, excitation signals are used, are equal. For the evaluation, for example, in each case, the envelope curves are ascertained, in order to obtain a virtually average amplitude of the oscillations via the time periods.

In an embodiment, the control unit is designed to judge the ability to function via an evaluation of an envelope curve of the received signals. In this embodiment, preferably a plurality of oscillations of the oscillatable unit in the case of applied excitation signal are received as received signal and evaluated via an envelope curve.

An embodiment includes that the control unit is designed to classify the sensor as non-functional when the amplitudes of the received signals for the different excitation signals do not or not suitably, or significantly, change. In this embodiment, it is checked and, in given cases, signaled, whether the received signal did not change suitably upon the change of the excitation signal.

In a supplementing or alternative embodiment, it is provided that the control unit is designed to classify the sensor as function capable when the amplitudes of the received signals for the different excitation signals change sufficiently, or significantly. If, thus, the required changes occur in the received signal, then the sensor is classified as function capable. Thus, especially no foreign vibrations are received, which are dominant compared with the actual oscillation of the mechanically oscillatable unit in the oscillatory circuit. It can likewise be assumed therefrom that no interruptions are present in the oscillatory circuit of amplifier unit and mechanically oscillatable unit, thus, especially no cable breaks or the like. Generally, the checking detects those failures, which basically prevent the mechanically oscillatable unit from performing resonant oscillations.

In general, thus, the following core of the invention is put into practice: The signal strengths of the excitation signals are modulated. If a modulation registers correspondingly also in the received signals, then the measuring device and, above all, the sensor of mechanically oscillatable unit and amplifier unit are in order. Therefore, also the measured variable can be reliably determined or monitored from the received signals. In the case of a modulation of the signal strengths of the excitation signals, the associated modulation would be the change of the amplitudes of the received signals. If, however, no modulation or not the appropriate modulation shows in the received signals, then a failure is present, which prevents that the mechanically oscillatable unit oscillates at the resonant frequency, which would actually set because of the oscillatory circuit and as a function of the medium. Such is, for example, correspondingly signaled.

An embodiment provides that the control unit is designed to apply a relative amplitude change of the received signals for evaluating the sensor. Thus, no absolute measurements are required. A relative amplitude change is, for example, the difference between the amplitudes of the two received signals referenced to one of the two amplitudes.

An embodiment provides that the control unit is designed, in the case, in which there results that the sensor is to be classified as function capable, to give the indication that a complete covering of the mechanically oscillatable unit could be present. In the case of complete covering, the medium prevents that the mechanically oscillatable unit oscillates. Through the transducer unit between the electrical signals and the mechanical oscillations, the excitation signal acts with a small part directly on the received signal. The signal part is, in such case, dependent on the signal strength of the excitation signal. This says, however, nothing about in which state—with exception of the transducer unit—the sensor is located. Anyway, there results alone from this signal already the information of failure freedom. The transducer unit is composed, for example, of at least one piezoelectric element. Consequently, there is given in this embodiment the indication that it could also be that the medium is completely covering the mechanically oscillatable unit.

In an embodiment, the mechanically oscillatable unit is an oscillatory fork, a single tine or a diaphragm.

Preferably the amplifier unit is embodied to produce the excitation signals with a phase shift of, for instance, 90° or 270° relative to the received signals. Alternatively, a phase shift of 270° is set.

In state of the art, the control unit can in the case of corresponding design determine the density of the medium and/or an upper, or lower, limit level, thus, generally the fill level of medium in a container, based on the frequency of the received signal, or of the excitation signal, as measured variable. The frequency evaluation takes place preferably in the case of liquids as medium.

The control unit in an embodiment is designed as an integral component of the sensor. Alternatively, a process control station or a decentral server functions as control unit. In general, the terminology “unit” means in the context of the invention, in principle, any electronic circuit or equipment or component suitably designed for its use. It can thus, depending on requirement, be an analog circuit for producing, or processing, corresponding analog signals. It can even be a (semiconductor based) digital circuit, such as an FPGA.

The invention will now be explained in greater detail based on the appended drawing, the figures of which show as follows:

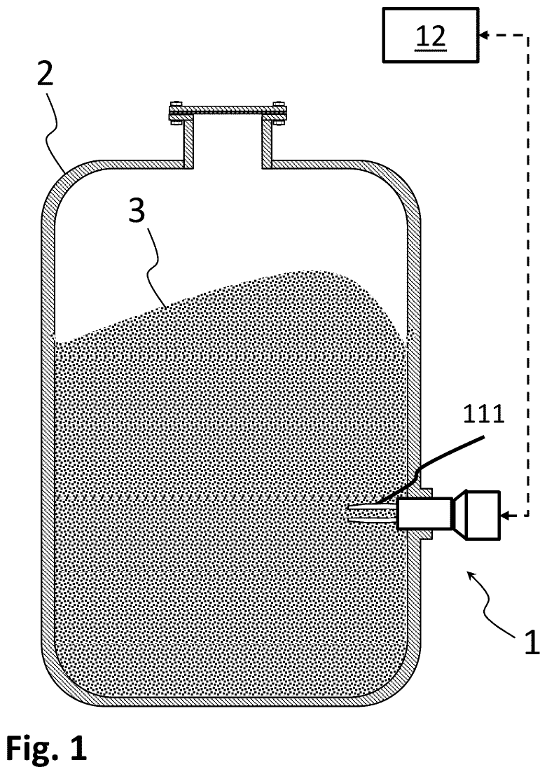

FIG. 1 a schematic arrangement of a measuring device of the invention on a container,

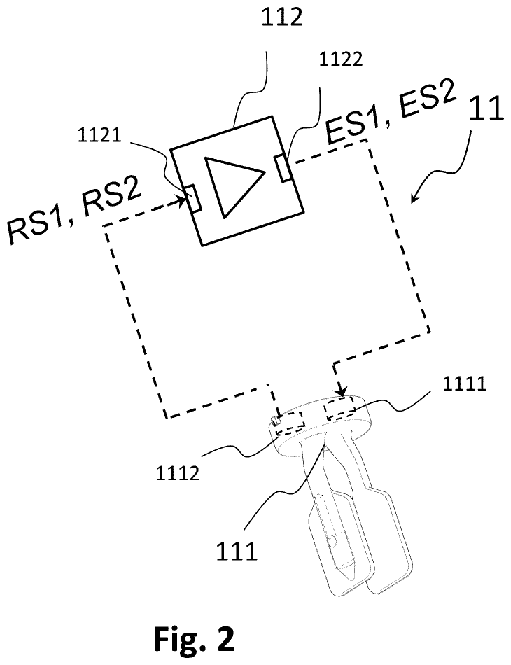

FIG. 2 the oscillatory circuit of the measuring device as an electrical circuit, and

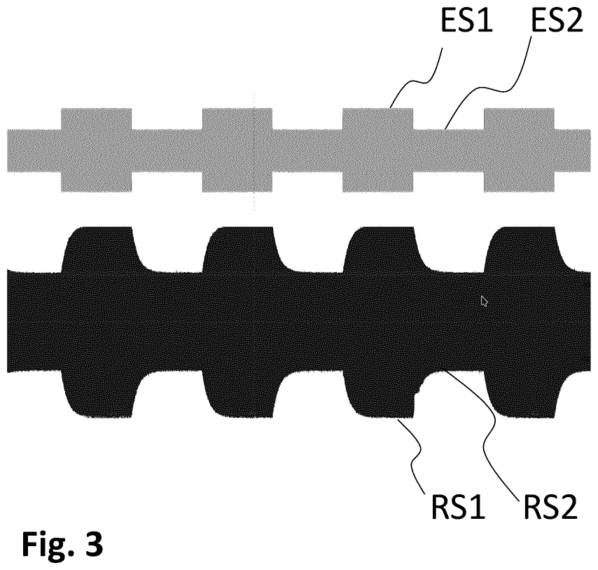

FIG. 3 by way of example, curves of excitation signals and received signals received in case of a functional sensor.

For providing a general understanding of the measuring device 1 of the invention, FIG. 1 shows a schematic arrangement of the measuring device 1 on a container 2.

In such case, a medium 3 is located in the container 2, wherein, for example, the density of the medium is to be determined or a fill level change is to be registered relative to a limit level. Medium 3 can be liquid or a bulk good.

The measuring device 1 is here, by way of example, connected with a remote control unit 12, for example, a process control system. In this way, the particular measured value can be transferred or a change displayed. Also other information concerning general operating state of the measuring device 1 can be communicated. Alternatively, the control unit 12 and the sensor 11 can be integral components of a measuring device 1.

For measuring, the measuring device 1 is arranged laterally at a port of the container 2, such as, for example, a flange connection. In the case of a density to be determined, the measuring device 1 does need to be arranged with respect to container height in such a manner that at least during the measuring the covering of the measuring device 1, thus its oscillatory fork 111, with medium 3 is assured. In the case of a limit level measurement, the measuring device 1 is to be arranged horizontally at the height of the container 2 corresponding to the limit level to be detected.

The operation of the measuring device 1 will now be explained based on the schematic circuit of an example of an embodiment in FIG. 2.

Shown is a vibronic sensor 11, which comprises as mechanically oscillatable element the oscillatory fork 111 and an amplifier unit 112 back coupled thereto. In such case, the amplifier unit 112 can operate based, for example, on at least one operational amplifier. For mechanical excitation, at least a first piezoelement 1111 is coupled to the oscillatory fork 111. In this way, upon supplying of the first piezoelement 1111 with an electrical excitation signal ES1, ES2, the oscillatory fork 111 is mechanically caused to perform oscillations with the corresponding frequency fR. Additionally, the oscillatory fork 111 has a second piezoelement 1112. In this way, the mechanical oscillations of the oscillatory fork 111 produce an electrical, received signal RS1, RS2, whose frequency fR corresponds, in turn, to that of the mechanical oscillations. The two piezoelements 1111, 1112 form, thus, together, a transducer unit.

Alternatively to the embodiment shown in FIG. 2, it is, moreover, an option to sense the received signal RS1, RS2 at the first piezoelement 1111, such that no second piezoelement 1112 is required. Proviso for this is that the signals ES1, RS1, and ES2, RS2 are separated from one another, for example, in that one signal is considered as electrical current-and the, other signal is considered as a voltage signal.

The signal RS1, RS2 received from the oscillatory fork 111 is led to an input 1121 of the amplifier unit 112, while the output 1122 of the amplifier unit 112 is connected to the first piezoelement 1111, and thus to the input for the electrical excitation signal ES1, ES2 at the oscillatory fork 111. There results, thus, a closed feedback loop.

The amplifier unit 112 sets a constant phase shift o between the entering received signal RS1, RS2 and the emanating excitation signal ES1, ES2 and has a constant or controlled amplification factor. I.e., the amplitude AR of the received signal RS1, RS2 is amplified and output to the output 1122 of the amplifier unit 112. By the amplification and the phase shift o controlled to a constant value or predetermined by corresponding filtering there forms correspondingly the oscillatory circuit 11, such that the frequency fR of the excitation signal ES1, ES2 agrees with that of the received signal RS1, RS2.

In such case, the frequency fR depends, on the one hand, on the phase shift o predetermined by the amplifier unit 112. On the other hand, the frequency fR is additionally determined by the resonant oscillation of the oscillatory fork 111, which depends on a possible covering of the oscillatory fork 111 with medium 2. Accordingly, by measuring the current frequency fR of the excitation signal ES1, ES2, or of the received signal RS1, RS2, a possibly reached limit level and/or density of the medium 2 can be determined, or monitored. For this, the frequency fR can be determined, for example, by the control unit 12.

FIG. 3 shows an example of the variation of the signal strength according to the invention. Involved in such case is a disturbance free measuring device 1.

In the upper row are the envelope curves of the excitation signals ES1, ES2. To be noticed, in such case, are the significantly different signal strengths, which continuously alternate and, thus, permit a continuous checking of the function of the measuring device. Such is, thus, an example for the fact that the monitoring of the measuring device 1 takes place continually and in parallel with the actual measurements. To be noticed is that with each excitation signal ES1, ES2 the excitation takes place over an extended length of time and alternatingly.

In the lower row are the received signals RS1, RS2 aligned with the excitation signals ES1, ES2. To be noticed is that a greater signal strength in the excitation signal leads to a greater amplitude in the received signal. From the fact that the modulation of the signal strengths of the excitation signals leads to the modulation of the amplitudes of the received signals, it can be assumed that the sensor is function capable and at least no dominant disturbing oscillations or other defects are present in the measuring device 1. In the case of a faulty measuring device, the amplitudes would not, or at least not measurably, change.

1-9. (canceled)

10. A measuring device for determining and/or monitoring a measured variable of a medium, comprising
a vibronic sensor and a control unit,
wherein the vibronic sensor includes a mechanically oscillatable unit and an amplifier unit,
wherein the mechanically oscillatable unit is excitable by an electrical excitation signal having an excitation oscillation frequency and produces a received signal having a resonance oscillation frequency,
wherein the amplifier unit is designed to produce the electrical excitation signal with a defined phase shift relative to the received signal and to excite the mechanically oscillatable unit with the electrical excitation signal,
wherein the control unit is designed to ascertain the resonance oscillation frequency and/or an amplitude of the received signal and, based on the ascertained resonance oscillation frequency and/or the ascertained amplitude of the received signal, to determine the measured variable of the medium,
wherein the control unit is designed to control the amplifier unit for a checking of the measuring device in such a manner that the amplifier unit produces at least two excitation signals with equal excitation oscillation frequency and different predeterminable signal strengths,
wherein the control unit is designed to judge the sensor relative to its ability to function depending on how the amplitudes of the received signals behave as a result of the different excitation signals, and
wherein the amplifier unit and the mechanically oscillatable unit form a closed oscillatory circuit.

11. The measuring device as claimed in claim 10,
wherein the control unit is designed to control the amplifier unit in such a manner that the amplifier unit produces essentially continually alternately two excitation signals with equal excitation oscillation frequency and different predeterminable signal strengths.

12. The measuring device as claimed in claim 10,
wherein the control unit is designed to judge ability to function via evaluation of an envelope curve of the received signals.

13. The measuring device as claimed in claim 10,
wherein the control unit is designed to classify the sensor as non-functional when the amplitudes of the received signals for the different excitation signals do not change.

14. The measuring device as claimed in claim 13,
wherein the control unit is designed to classify the sensor as function capable when the amplitudes of the received signals change for the different excitation signals.

15. The measuring device as claimed in 10,
wherein the control unit is designed, to apply a relative amplitude change of the received signals for evaluating the sensor.

16. The measuring device as claimed in claim 14,
wherein the control unit is designed, in the case in which there results that the sensor is to be classified as function capable, to give an indication that a complete covering of the mechanically oscillatable unit could be present.

17. The measuring device as claimed in claim 10,
wherein the amplifier unit is designed to produce the excitation signals with a phase shift of 90° or 270°.

18. The measuring device as claimed in claim 10,
wherein the mechanically oscillatable unit is an oscillatory fork, a single tine or a diaphragm.
